(19) United States
(12) Patent Application Publication
(10) Pub. No.: US 2012/0097755 A1
(43) Pub. Date: Apr. 26, 2012

(54) Shotcrete Carrier and Method of Applying Shotcrete

(76) Inventor: Georg Nickel, Winnipeg (CA)

(21) Appl. No.: 12/909,957

(22) Filed: Oct. 22, 2010

(51) Int. Cl. E04G 21/04; B05B 7/14; B05B 7/26

(52) U.S. Cl. 239/8; 239/722; 239/310; 239/325

(57) ABSTRACT

A shotcrete carrier includes a dry mix hopper, a wet mix shotcrete spraying machine, and a mixing auger for wetting the dry mix as it is conveyed from the dry mix hopper to the shotcrete spraying machine on a common mobile frame. The shotcrete spraying machine comprises an inlet hopper receiving the wet mix shotcrete from the mixing auger, and a rotor with chambers rotatable from a loading position in communication with the inlet hopper and a discharging position in communication with a pneumatic conveying line. The pneumatic conveying line conveys the wet mix shotcrete to a nozzle commonly supported on the mobile frame.

### FIELD OF THE INVENTION

The present invention relates to shotcrete carrier including a dry mix hopper, a wet mix shotcrete spraying machine, and a mixing auger for wetting the dry mix as it is conveyed from the dry mix hopper to the shotcrete spraying machine on a common mobile frame, and more particularly relates to a method of applying shotcrete using a single vehicle carrier.

### BACKGROUND

Shotcrete is commonly applied by either a wet mix method or a dry mix method. In the wet mix method water, cement and aggregate are typically mixed together and pumped by a concrete piston pump to a spray nozzle where accelerator is mixed with the cement. Compressed air is supplied at the nozzle for propelling the wet mix of shotcrete onto the target surface.

Use of the wet mix method typically requires use of two separate vehicles to be operated at the job site. The first vehicle includes a drum carrying the wet mix of water, cement and aggregate therein for pumping to a separate vehicle which pumps the concrete to a nozzle on an applicator boom where compressed air and accelerator are added for propelling the mixture onto the target surface. An example of the two vehicle system for employing the wet mix method is available by Normet Corporation of Finland in which a concrete transporter is available under the tradename Utimec 1500 Transmixer and a diesel hydraulic shotcreter is available under the tradename Spraymec 6050WP. When used in mines in particular, the use of two separate vehicles imposes considerable additional ventilation requirements upon the mine. Furthermore a second operator is required for the second vehicle further increasing the cost of the operation. Due to the handling and pumping required of the wet mix, typically the mixture in the concrete transporter must be quite fluid resulting in extended setting times once sprayed onto the target surface.

One means of measuring the fluidity of a concrete mixture is generally referred to as the amount of slump. In this instance a pile of the wet concrete mixture is placed into a form so that the resulting pile has an apex of approximately 12 inches in height. Upon removal of the form, the amount of reduction in height of the pile from the initial 12 inch starting height as the concrete mixture settles determines the amount of slump. In the instance of the two vehicle handling according to the wet mix method of Normet, a very fluid mixture corresponding to a slump of approximately 8 inches is required to accommodate the handling and pumping of the concrete.

According to the dry mix method, a dry mixture of cement, aggregate and other dry additives such as dry accelerator are dispensed directly into a concrete spraying machine often referred to as a shotcrete gun as described in U.S. Pat. No. 5,094,403 by Sandoz Limited. The shotcrete gun includes an inlet hopper for receiving the dry mixture and for dispensing the dry mixture into circumferentially spaced chambers of a rotor which rotate between a loading position in communication with the hopper and a discharge position in communication with a pneumatic conveying line. The handling of the dry mixture is often very dusty and undesirable in enclosed spaces. Water is added with the dry mixture from the pneumatic conveying line at a mixer just before the spray nozzle so that the cement mixture has minimal time to mix with the water prior to being dispensed onto the target surface which can result in a poor mixture quality.

In some instances the wet mix method can be applied using a shotcrete gun instead of a pump, however two separate vehicles are still required so that one vehicle handles an already prepared wet mix of shotcrete while the other vehicle supports the shotcrete gun. One example of a shotcrete spraying machine adapted for receiving a wet mix is available by Aliva of Switzerland under the model number AL-263. This concrete spraying machine includes an inlet hopper in communication with chambers in a rotor movable between a loading position and a dispensing position similarly to the shotcrete gun described above but modified to fill the chambers more readily with a wet mixture instead of a dry mixture.

### SUMMARY OF THE INVENTION

According to one aspect of the invention there is provided a mobile shotcrete carrier for applying shotcrete to a target surface, the carrier comprising:

a carrier frame;

a dry mix hopper supported on the carrier frame and arranged to receive a dry mix of cement and aggregate therein;

a mixing auger comprising an inlet end, a water connection, and a discharge end, wherein the inlet end is arranged to receive the dry mix from the dry mix hopper, the water connection is arranged for connection to a water supply so as to transform the dry mix to a wet mix of shotcrete while being conveyed from the inlet end to the discharge end, and the discharge end is arranged to dispense the wet mix of shotcrete therefrom;

a shotcrete spraying machine supported on the carrier frame, the shotcrete spraying machine comprising:
an inlet hopper arranged to receive the wet mix of shotcrete therein from the discharge end of the mixing auger;
a pneumatic conveying line arranged to convey the wet mix of shotcrete therethrough; and
a drum rotor including a plurality of chambers therein in which each chamber is rotatable with the drum rotor between a loading position in communication with the inlet hopper so as to be arranged to receive the wet mix of shotcrete from the inlet hopper and a discharging position in communication with the pneumatic conveying line so as to be arranged to dispense the wet mix of shotcrete therein to the pneumatic conveying line;

a nozzle supported on the carrier frame and arranged to spray the wet mix of shotcrete from the pneumatic conveying line onto the target surface.

The carrier according to the present invention permits the application of shotcrete according to a hybrid process incorporating some elements from both the wet and dry mix processes described above, but in a modified form to overcome some of the disadvantages associated with both prior methods. The present invention is most advantageous by allowing a single vehicle to transport kiln dried premixed shotcrete including the mixer, conveying pump and robotic spray boom all on a common frame. By transporting the mix as a dry mix, no excess material is wasted as occurs in premixed wet mix shotcrete as the dry mix can always be reused at a later date. The carrier is adapted so that only the material required for immediate spraying is mixed resulting in less dumping due to old or over ordered materials. Use of a mix auger to mix the water with the dry mix results in a better shotcrete mix than the addition of water only at the nozzle as occurs in the dry mix method. Adding the water just before the shotcrete gun involves a minimum amount of handling requirements for the wet shotcrete mix so that the mix can be made to be much thicker than prior art wet mix processes where additional handling between two different vehicles is required. The thicker mix having less slump results in a shorter cure time. Since the present invention uses thin stream spraying, low slump materials work well, resulting in significant reduction in chemical usage, for example no super plasticizer or retarders is needed. Furthermore the low slump material yields a significant reduction in accelerator usage which saves money and provides higher final strength. Also due to the transporting of the dry material, the single carrier is capable of hauling up to 12 cubic yards of kiln dried material since it is lighter weight due to the water being added just before mixing and pumping by the shotcrete spraying machine. Conventional systems have a maximum capacity of approximately 8 cubic yards.

Preferably the water connection communicates with the mixing auger adjacent the inlet end and the mixing auger extends at an upward inclination from the inlet end to the discharge end. In the preferred embodiment, the mixing auger has an auger pitch of approximately ⅔.

When the mixing auger is rotatably supported in an auger tube extending from the inlet end to the outer end, the water connection preferably comprises a plurality of spray nozzles in communication through the auger tube. The spray nozzles preferably comprise a wide spray pattern, for example greater than 45 degrees, or more preferably greater than 90 degrees.

Preferably there is also provided a metering mechanism, for example a metering auger, in communication between the dry mix hopper and the inlet end of the mixing auger which is arranged to convey a metered amount of dry mix to the mixing auger.

Preferably the mixing auger has a greater capacity than the metering auger and is arranged to be operated at a greater RPM than the metering auger, for example in a range of 150 to 250 RPM.

The metering auger may be supported in a substantially horizontal orientation across one end of the dry mix hopper. In this instance, a plurality of feed augers may be supported in the dry mix hopper so as to be arranged to convey dry mix across the bottom of the dry mix hopper into the metering auger.

In the illustrated embodiment, there is provided only one internal combustion engine on the mobile frame for driving movement of the mobile frame across the ground and for driving the mixing auger and shotcrete spraying machine.

Preferably there is provided an accelerator tank in communication with the nozzle so as to be arranged to add accelerator to the wet mix of shotcrete adjacent the nozzle.

When the carrier frame is supported for rolling movement in a forward working direction, preferably the nozzle is supported adjacent a front end of the carrier frame, the mixing auger and the shotcrete spraying machine are supported adjacent a rear end of the carrier frame, and the dry mix hopper is supported at an intermediate location on the frame between the front and rear ends.

According to a second aspect of the present invention there is provided a method of applying shotcrete to a target surface, the method comprising:

providing a shotcrete carrier comprising:
a carrier frame;
a dry mix hopper supported on the carrier frame;
a mixing auger comprising an inlet end, a water connection arranged for connection to a water supply, and a discharge end;
a shotcrete spraying machine supported on the carrier frame, the shotcrete spraying machine comprising an inlet hopper, a pneumatic conveying line, and a drum rotor including a plurality of chambers therein in which each chamber is rotatable with the drum rotor between a loading position in communication with the inlet hopper and a discharging position in communication with the pneumatic conveying line; and
a nozzle supported on the carrier frame;

providing a dry mix of cement and aggregate in the dry mix hopper;

transferring the dry mix from the dry mix hopper to the inlet end of the mixing auger;

adding water from the water supply through the water connection to the dry mix in the mixing auger so as to transform the dry mix into a wet mix of shotcrete while being conveyed from the inlet end to the discharge end of the mixing auger;

dispensing the wet mix of shotcrete from the mixing auger to the inlet hopper of the shotcrete spraying machine;

rotating the drum rotor so as to load the chambers of the drum rotor with the wet mix of shotcrete and transfer the wet mix of shotcrete to the pneumatic conveying line;

conveying the wet mix of shotcrete through the pneumatic conveying line from the shotcrete spraying machine to the nozzle; and

spraying the wet mix of shotcrete from nozzle onto the target surface.

The method may include mixing the wet mix shotcrete in the mixing auger to a consistency corresponding to a slump of between 3 and 5 inches.

Preferably the water is added to the dry mix in the mixing auger adjacent the inlet end of the mixing auger and the wet mix of shotcrete is discharged from the discharge end of the mixing auger directly into the inlet hopper of the shotcrete spraying machine.

Preferably the mixing auger is operated to be only partially full of the wet mix of shotcrete as it is conveyed from the inlet end to the discharge end of the mixing auger.

One embodiment of the invention will now be described in conjunction with the accompanying drawings in which:

### BRIEF DESCRIPTION OF THE DRAWINGS

FIG. 1 is a perspective view of a first side of the carrier.

FIG. 2 is a perspective view of a second side of the carrier.

FIG. 3 and FIG. 4 are side elevational views of the first and second sides of the carrier respectively.

FIG. 5 is a rear elevational view of the carrier.

FIG. 6 is a top plan view of the dry mix hopper on the rear portion of the carrier with the hopper lid shown removed.

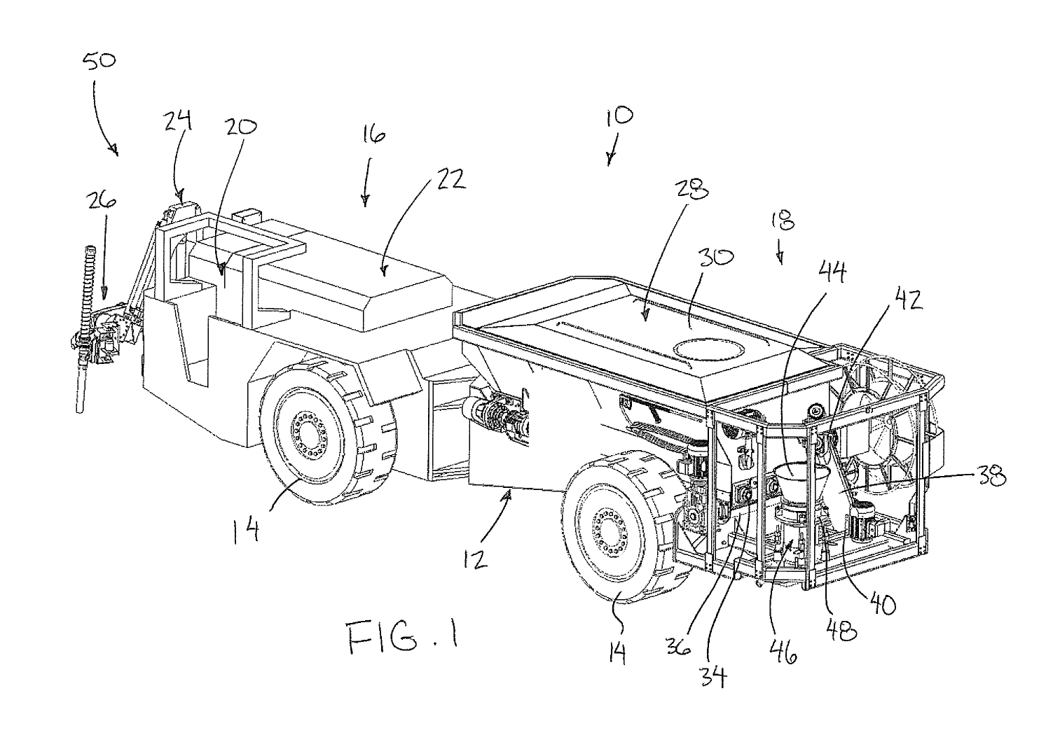

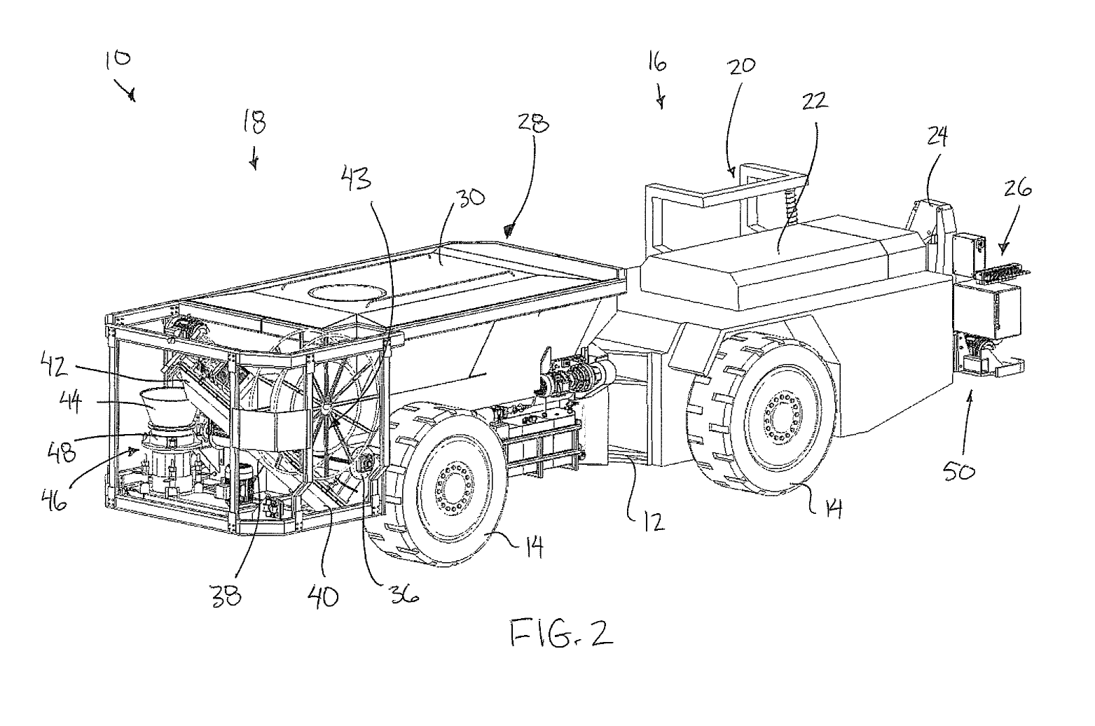

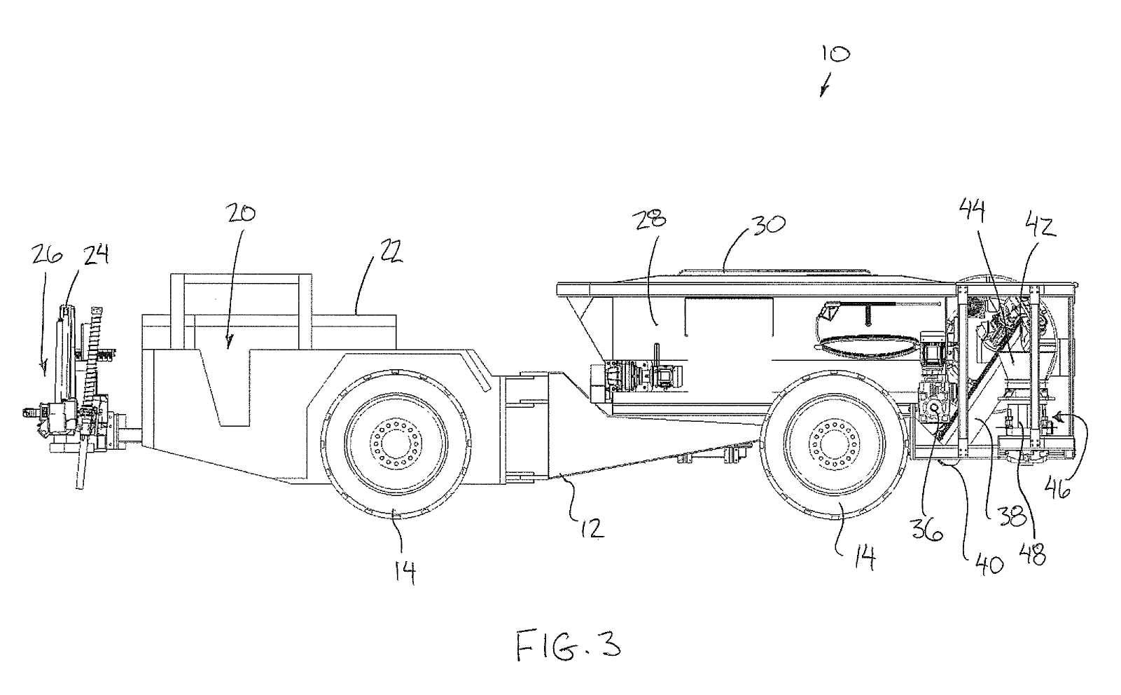

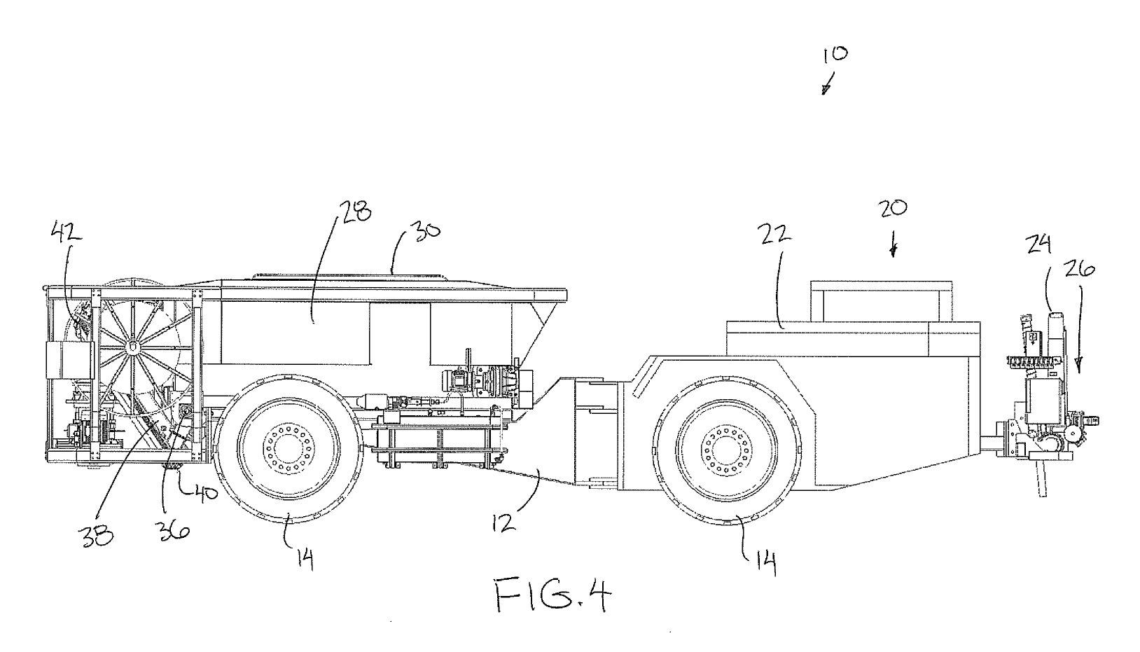

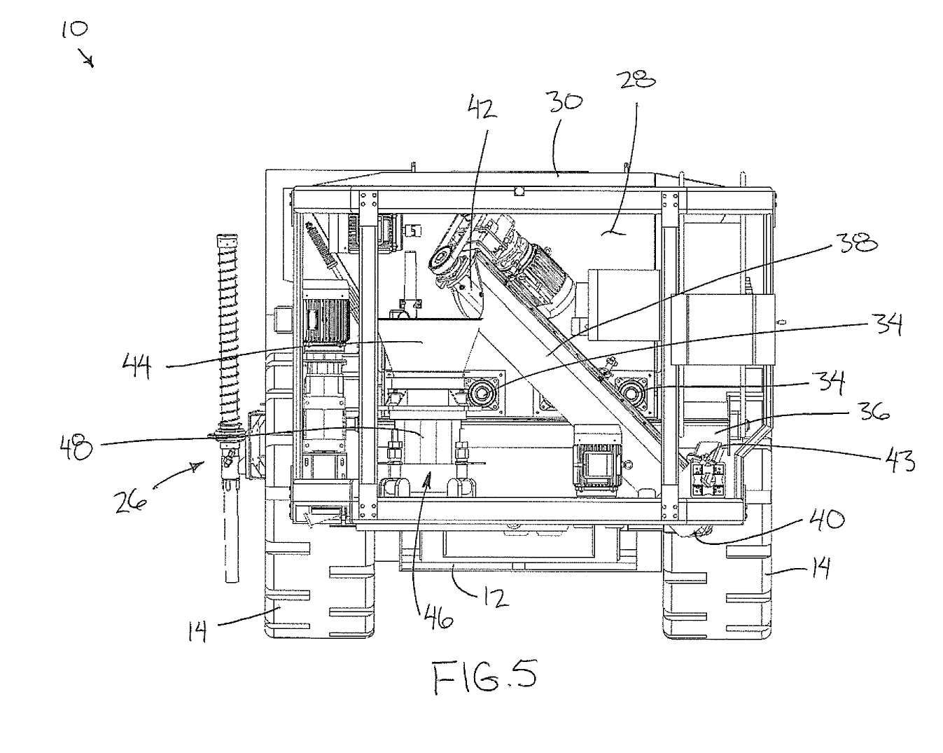

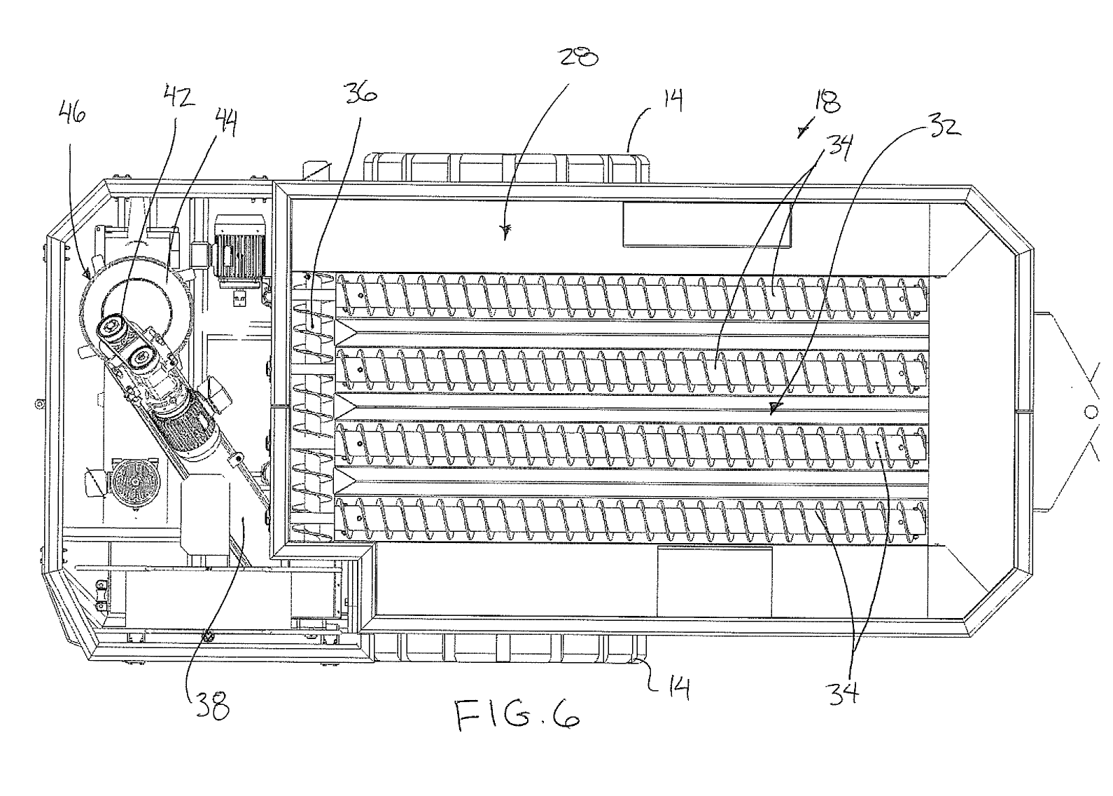

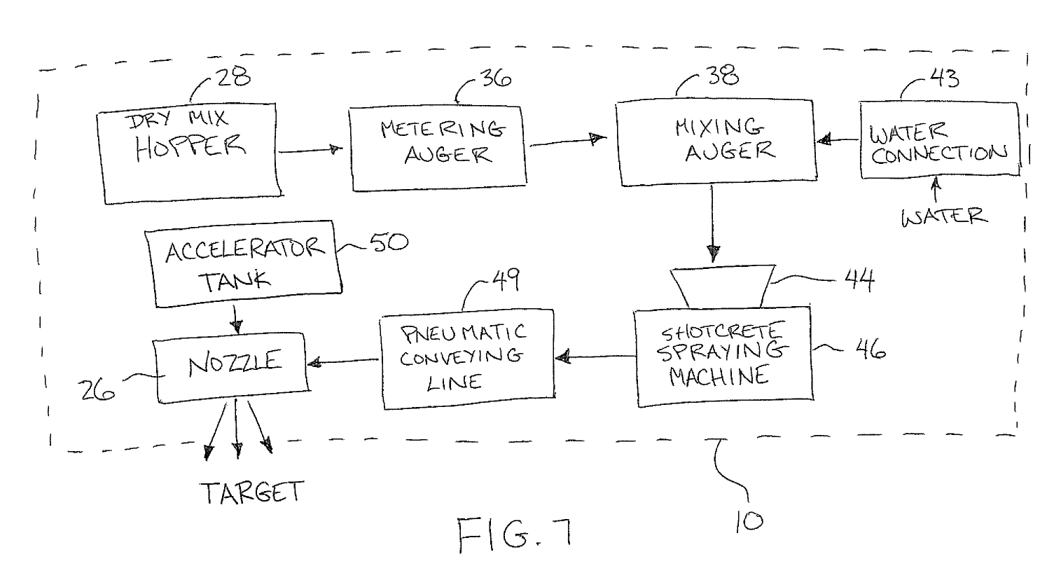

In the drawings like characters of reference indicate corresponding parts in the different figures.

### DETAILED DESCRIPTION

Referring to the accompanying figures there is illustrated a hybrid shotcrete carrier generally indicated by reference number 10. The carrier 10 is particularly suited for transporting a dry mix of shotcrete to a job site where the dry mix is subsequently mixed with water and conveyed to a nozzle on a spray boom all on a single vehicle.

The carrier 10 comprises a vehicle frame 12 supported on wheels 14 for rolling movement in a forward working direction. The frame 12 is an articulating frame including a front portion 16 and a rear portion 18 pivotally coupled to one another for relative movement about a vertical steering axis at an intermediate location between the front and rear portions of the frames. Each of the front end rear portions are supported on a respective pair of wheels rotatable about a common axis with the 2 axles being steerable relative to one another by articulating the front and rear portions of the frame relative to one another.

The front portion 16 of the carrier frame includes an operator control 20 adjacent the front end for driving the vehicle and for operating the various components of the carrier. The front portion further supports an internal combustion engine and generator within an engine housing 22.

A spray boom 24 is mounted on the front end of the vehicle frame. The boom 24 is steerable under robotic controls at the operator control 20 for directing a nozzle 26 used for spraying the shotcrete onto a target surface.

The rear portion of the frame supports a dry mix hopper 28 thereon. The dry mix hopper occupies most of the rear portion of the frame towards the center of the vehicle at a generally intermediate location between the front and rear ends of the carrier. The hopper is sufficiently large for accommodating approximately 12 cubic yards of kiln dried material. The material within the hopper typically includes cement, aggregate and other dry additives forming a dry mix. The hopper includes upright walls about a generally rectangular perimeter which are tapered somewhat downwardly and inwardly from a top end enclosed by a lid 30 to a substantially flat bottom 32 locating a plurality of feed augers 34 spanning thereacross.

The feed augers 34 are supported parallel to one another to extend generally in the longitudinal direction from the front to the back of the hopper such that the feed augers substantially fully span the bottom of the hopper. The augers are driven by suitable electric motors which are driven by the generator in the engine housing 22. The feed augers are operated to convey the material from the bottom of the hopper rearwardly towards a metering auger 36 spanning the rear end of the hopper. More particularly the metering auger 36 spans horizontally across the width of the hopper at the bottom end in communication with the feed augers so that the feed augers fill the metering auger and keep the metering auger substantially full throughout its operation. The metering auger conveys the dry mix to a discharge at one side of the carrier and serves to deliver a metered amount of the dry mix from the hopper.

A mixing auger 38 is also supported at the rear end of the rear portion of the frame together with the metering auger. The mixing auger is oriented at an upright inclination, for example at a slope of approximately 45 degrees, from an inlet end 40 to a discharge end 42. The auger includes a surrounding tube spanning the length of the auger which rotatably receives a shaft of the auger upon which the auger flighting is supported for rotation relative to the surrounding tube. The auger flighting is arranged to substantially span the full diameter of the tube while having a pitch of approximately ⅔.

The inlet end of the mixing auger is coupled to the metering auger to receive the metered amount of dry mix therefrom. The flighting of the mixing auger is driven to rotate by a suitable electric motor which is also driven by the generator in the engine housing 22. In the illustrated embodiment the mixing auger has a larger capacity than the meeting auger and is driven to rotate at a faster rate than the metering auger so that in operation the mixing auger is only maintained to be approximately half full even though the metering auger is operated to remain full.

The mixing auger 38 includes a water connection 43 in the form of a plurality of nozzles communicating through the external tube of the mixing auger. The plurality of nozzles are located adjacent the inlet end of the mixing auger and have a wide spray pattern, for example 90 degrees or more in spread. The water connection is arranged for connection to a water supply, for example by connection through a suitable hose to an external supply of water. The water is added by the water connection to the dry mix in a metered amount as the metered amount of dry mix enters the auger. The mixing auger 38 thus serves to mix the water and dry mix to transform the dry mix to a wet mix of shotcrete while the material is conveyed from the inlet end to the discharge end. The mixture is typically controlled to have a consistency corresponding to 4 inches of slump.

The discharge end of the mixing auger discharges directly into the inlet hopper 44 of a shotcrete spraying machine 46 located directly below the discharge of the mixing auger at the rear end of the frame of the carrier. The inlet hopper has an open top end receiving the wet mix from the mixing auger and for directing the wet mix for sequentially filling the upright tubular chambers of a drum rotor 48 of the shotcrete spraying machine.

The shotcrete spraying machine can be arranged substantially identical to the spray machine available under model AL-263 by Aliva previously described. In this instance each of the tubular chambers of the drum rotor are circumferentially spaced and have open top and bottom ends. The rotor rotates about a vertical axis such that each of the tubular chambers is rotated between a loading position in communication with the hopper thereabove and a discharging position in communication with a pneumatic conveying line 49. In the loading position, a vent line is provided in communication with the chamber being filled for evacuating the air from the chamber as the chamber is filled with wet mix. In the discharging position, the filled chamber is aligned in series between a source of compressed air and a pneumatic conveying line such that the compressed air conveys the charge of wet mix in the chamber into the pneumatic conveying line. The wet mix is further discharged through the pneumatic conveying line to the nozzle on the spray boom at the front end of the carrier frame.

An accelerator tank 50 including a chemical accelerator therein is also located at the front end of the carrier frame. The accelerator tank communicates a metered amount of accelerator into the wet mix of the pneumatic conveying line adjacent the nozzle for mixing with the wet mix just prior to the mixture being sprayed from the nozzle onto the target surface.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A mobile shotcrete carrier for applying shotcrete to a target surface, the carrier comprising:
a carrier frame;
a dry mix hopper supported on the carrier frame and arranged to receive a dry mix of cement and aggregate therein;
a mixing auger comprising an inlet end, a water connection, and a discharge end, wherein the inlet end is arranged to receive the dry mix from the dry mix hopper, the water connection is arranged for connection to a water supply so as to transform the dry mix to a wet mix of shotcrete while being conveyed from the inlet end to the discharge end, and the discharge end is arranged to dispense the wet mix of shotcrete therefrom;
a shotcrete spraying machine supported on the carrier frame, the shotcrete spraying machine comprising:
an inlet hopper arranged to receive the wet mix of shotcrete therein from the discharge end of the mixing auger;
a pneumatic conveying line arranged to convey the wet mix of shotcrete therethrough; and
a drum rotor including a plurality of chambers therein in which each chamber is rotatable with the drum rotor between a loading position in communication with the inlet hopper so as to be arranged to receive the wet mix of shotcrete from the inlet hopper and a discharging position in communication with the pneumatic conveying line so as to be arranged to dispense the wet mix of shotcrete therein to the pneumatic conveying line;
a nozzle supported on the carrier frame and arranged to spray the wet mix of shotcrete from the pneumatic conveying line onto the target surface.

2. The carrier according to claim 1 wherein the water connection communicates with the mixing auger adjacent the inlet end.

3. The carrier according to claim 1 wherein the mixing auger extends at an upward inclination from the inlet end to the discharge end.

4. The carrier according to claim 1 wherein the mixing auger has an auger pitch of approximately ⅔.

5. The carrier according to claim 1 wherein the mixing auger is rotatably supported in an auger tube extending from the inlet end to the outer end and wherein the water connection comprises a plurality of spray nozzles in communication through the auger tube.

6. The carrier according to claim 5 wherein the spray nozzles comprise a wide spray pattern greater than 45 degrees.

7. The carrier according to claim 1 wherein there is provided a metering mechanism in communication between the dry mix hopper and the inlet end of the mixing auger and arranged to convey a metered amount of dry mix to the mixing auger.

8. The carrier according to claim 7 wherein the metering mechanism comprises a metering auger and the mixing auger is arranged to be operated at a greater RPM than the metering auger.

9. The carrier according to claim 7 wherein the metering mechanism comprises a metering auger and the mixing auger has a greater capacity than the metering auger.

10. The carrier according to claim 7 wherein the metering mechanism comprises a metering auger and the metering auger is substantially horizontal in orientation.

11. The carrier according to claim 7 wherein the metering mechanism comprises a metering auger and the metering auger is supported across one end of the dry mix hopper and wherein there is provided a plurality of feed augers supported in the dry mix hopper so as to be arranged to convey dry mix across the bottom of the dry mix hopper into the metering auger.

12. The carrier according to claim 1 wherein the mixing auger is arranged to be operated in a range of 150 to 250 RPM.

13. The carrier according to claim 1 wherein there is provided only one internal combustion engine on the mobile frame for driving movement of the mobile frame across the ground and for driving the mixing auger and shotcrete spraying machine.

14. The carrier according to claim 1 wherein there is provided an accelerator tank in communication with the nozzle so as to be arranged to add accelerator to the wet mix of shotcrete adjacent the nozzle.

15. The carrier according to claim 1 wherein the carrier frame is supported for rolling movement in a forward working direction, the nozzle being supported adjacent a front end of the carrier frame, the mixing auger and the shotcrete spraying machine being supported adjacent a rear end of the carrier frame, and the dry mix hopper being supported at an intermediate location on the frame between the front and rear ends.

16. A method of applying shotcrete to a target surface, the method comprising:
providing a shotcrete carrier comprising:
a carrier frame;
a dry mix hopper supported on the carrier frame;
a mixing auger comprising an inlet end, a water connection arranged for connection to a water supply, and a discharge end;
a shotcrete spraying machine supported on the carrier frame, the shotcrete spraying machine comprising an inlet hopper, a pneumatic conveying line, and a drum rotor including a plurality of chambers therein in which each chamber is rotatable with the drum rotor between a loading position in communication with the inlet hopper and a discharging position in communication with the pneumatic conveying line; and
a nozzle supported on the carrier frame;
providing a dry mix of cement and aggregate in the dry mix hopper;
transferring the dry mix from the dry mix hopper to the inlet end of the mixing auger;
adding water from the water supply through the water connection to the dry mix in the mixing auger so as to transform the dry mix into a wet mix of shotcrete while being conveyed from the inlet end to the discharge end of the mixing auger;
dispensing the wet mix of shotcrete from the mixing auger to the inlet hopper of the shotcrete spraying machine;
rotating the drum rotor so as to load the chambers of the drum rotor with the wet mix of shotcrete and transfer the wet mix of shotcrete to the pneumatic conveying line;
conveying the wet mix of shotcrete through the pneumatic conveying line from the shotcrete spraying machine to the nozzle; and
spraying the wet mix of shotcrete from nozzle onto the target surface.

17. The method according to claim 16 including mixing the wet mix shotcrete in the mixing auger to a consistency corresponding to a slump measurement of between 3 and 5 inches.

18. The method according to claim 16 including adding the water to the dry mix in the mixing auger adjacent the inlet end of the mixing auger and discharging the wet mix of shotcrete from the discharge end of the mixing auger directly into the inlet hopper of the shotcrete spraying machine.

19. The method according to claim 16 including orienting the mixing auger at an upward inclination from the inlet end to the discharge end.

20. The method according to claim 16 including operating the mixing auger to be only partially full of the wet mix of shotcrete as it is conveyed from the inlet end to the discharge end of the mixing auger.
